(19) United States
(12) Patent Application Publication
(10) Pub. No.: US 2025/0137410 A1
(43) Pub. Date: May 1, 2025

(54) GAS TURBINE SYSTEM WITH DIFFUSION-FLAME COMBUSTION AND FUEL BLENDING FOR REDUCING UNDESIRED EMISSIONS

(71) Applicant: NUOVO PIGNONE TECNOLOGIE - S.R.L., Florence (IT)

(72) Inventors: Marco BALDINI, Firenze (IT); Alessio MILIANI, Firenze (IT); Alessandro ZUCCA, Firenze (IT); Rossella PALMIERI, Firenze (IT); Gaetano LOMBARDI, Firenze (IT)

(21) Appl. No.: 18/730,642

(22) PCT Filed: Jan. 24, 2023
(86) PCT No.: PCT/EP2023/025035

§ 371 Date: Jul. 19, 2024

(30) Foreign Application Priority Data
Jan. 24, 2022 (IT) 102022000001079

(51) Int. Cl. F02C 9/40; F02C 3/22; F02C 3/30

(52) U.S. Cl. CPC F02C 9/40; F02C 3/22; F02C 3/30

(57) ABSTRACT

A gas turbine system with a compressor section configured to compress an oxidant flow and provide a compressed oxidant flow at a combustor section. The combustor section receives the oxidant and a fuel gas-mixture separately, the mixture containing at least a fuel gas and an inert gas, to perform diffusion-flame combustion of the fuel and the oxidant in a combustion chamber and to provide a flue-gas flow to a turbine section configured to expand the flue-gas flow and to discharge the expanded flue-gas flow at a turbine outlet. The gas turbine system has also a blending unit configured to mix at least the fuel gas and the inert gas and provide the fuel gas-mixture at the combustor section with a blending ratio depending on a content of the flue gas, for example depending on a content of NOx and/or CO and/or CO2 of the flue gas measured or predicted.

### TECHNICAL FIELD

The subject-matter disclosed herein relates to a gas turbine system with diffusion-flame combustion and fuel blending for reducing partially or totally undesired emissions, in particular NOx emissions and possibly CO and/or CO2 emissions by regulating fuel blending; regulation of fuel blending is advantageously performed based on a NOx and/or CO and/or CO2 content in flue gas of the gas turbine system.

### BACKGROUND ART

Conventional gas turbine engines operates by compressing an oxidant, typically air, to high pressure, burning a fuel with the oxidant to generate a flue-gas flow at high pressure and temperature and then expanding the high-pressure high-temperature flue-gas flow through an expander to produce work and possibly to generate electric energy. Typically, gas turbine engines use natural gas, which is often predominantly methane with much smaller quantities of slightly heavier hydrocarbons such as ethane, propane and butane, or liquefied petroleum gas, which is propane and/or butane with traces of heavier hydrocarbons, as fuel.

Gas turbine combustion systems can be of two types: with diffusion flame or with premixed flame. In diffusion combustion systems, fuel and oxidant (e.g. air), are injected separately into the reaction zone of the combustor and perform a combustion which is totally or nearly stoichiometric. However, due to the fact that in diffusion combustion systems the combustion is totally or nearly stoichiometric, it is difficult (if not impossible) to control NOx emissions, in particular to control the formation of “thermal NOx”, which forms from the oxidation of the free nitrogen in the oxidant (e.g. air) or the fuel. Thermal NOx is strongly dependent on the stoichiometric adiabatic flame temperature of the fuel, which is the temperature reached by burning a stochiometric mixture of fuel and oxidant (e.g. air) in an insulated vessel, and more weakly on the concentration of oxygen and nitrogen.

In the last decades, emissions regulations have become more stringent in order to limit environmental damages. Attempts were made to limit NOx emissions from diffusive flame combustion systems by adding water or steam directly in the reaction zone of the combustor to reduce flame temperatures. Other attempts were made of removing NOx (possibly also CO and/or CO2) directly from the flue-gas flow; for example, NOx emissions may be reduced by adding a Selective Catalytic Reduction System downstream the expander of the gas turbine system.

However, the recent further tightening of emissions requirements led to the introduction and dissemination of premixed combustion systems such as Dry Low NOx (DLN) or Dry Low Emission (DLE) combustors. In premixed combustors, fuel and oxidant (e.g. air) are mixed upstream the reaction zone of the combustor and therefore are typically optimized for NOx low-emissions operation. For example, it is known from EP2204561A2 a system and method for blending a secondary gas, for example an alternate gas fuel such as hydrogen, ethane, butane, propane, LNG etc. or an inert gas, such as nitrogen and carbon dioxide, with a primary gas fuel, in particular natural gas, in a DLN gas turbine combustor. In these types of combustors, the amount of hydrogen blended is limited due to risk of the flame instability and therefore a significant quantity of natural gas is always present and consequently CO and/or CO2 emissions are significant. Hence, premixed combustion does not allow to reach a full decarbonization of the system.

However, traditional diffusion combustion systems still offer higher fuel flexibility, higher flame stability and lower (or even null) CO and CO2 emission than premixed combustors, even if they may have NOx emission problems at least in view of the ever increasing low-emission requirements.

### SUMMARY

It would be desirable to have a gas turbine system with diffusion-flame combustion having partially or totally reduced undesired emissions, in particular NOx emissions and possibly CO and/or CO2 emissions.

In particular, it would be desirable to provide a solution that may offer higher fuel flexibility, higher flame stability and lower CO and/or CO2 emissions than premixed combustors, for example a solution which may burn a fuel that has up to 100% by volume of hydrogen (and e.g. down to 0% by volume of natural gas or another secondary fuel); hydrogen may be for example 50%, 60%, 70%, 80% or 90% and may even vary over time for different reasons.

In particular, it would be desirable to provide a solution that may be easily applied even to gas turbine systems already installed and operating so that these systems may comply with more stringent emissions requirements.

According to an aspect, the subject-matter disclosed herein relates to a gas turbine system with a compressor section configured to compress an oxidant flow and to provide a compressed oxidant flow at a combustor section, at which a gas-mixture of a fuel gas and an inert gas is further supplied separately from the oxidant. The combustor section is configured to perform diffusion-flame combustion of the fuel and the oxidant in a combustion chamber and to provide a flue-gas flow to a turbine section configured to expand the flue-gas flow and to discharge the expanded flue-gas flow at a turbine outlet. The gas turbine system has also a blending unit configured to mix at least the fuel gas and the inert gas and provide the gas mixture at the combustor section with a blending ratio depending on a content of the flue gas, for example depending on a content of NOx and/or CO and/or CO2 of the flue gas. The blending unit is configured to mix the fuel gas and the inert gas under control of a control unit, which is configured to control operation of the gas turbine system.

In view of possible retrofitting, such an innovative gas turbine system is particularly suitable for burning air with hydrogen or a gas mixture containing hydrogen; preferably, the inert gas is nitrogen or contains predominantly nitrogen as it is readily available and low-cost.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a simplified diagram of an embodiment of a gas turbine system with fuel blending and continuous emissions monitoring system (CEMS),

FIG. 2 shows a simplified diagram of another embodiment of the gas turbine system with fuel blending and predictive emissions monitoring system (PEMS), and

FIG. 3 shows a simplified diagram of another embodiment of the gas turbine system with fuel blending and predictive emissions monitoring system (PEMS) during a learning phase combined with a continuous emissions monitoring system (CEMS).

### DETAILED DESCRIPTION OF EMBODIMENTS

According to an aspect, the subject-matter disclosed herein relates to a gas turbine system with diffusion-flame combustion which allows to reduce undesired emissions, in particular NOx emissions and possibly CO and/or CO2 emissions, by blending a fuel gas, for example hydrogen, with an inert gas, for example nitrogen, and possibly with an additional fuel gas, for example natural gas. The amount of fuel gas, inert gas and additional fuel gas in the gas mixture is controlled by a control unit which regulates the opening and closing of the inlet valves that supplies the gases to a blending unit. The blending unit generates the gas mixture to be burned, together with an oxidant, for example air, in the diffusion-flame combustor of the gas turbine to generate flue gas which are expanded in the expander of the gas turbine, typically to drive an equipment mechanically coupled to the gas turbine, for example a compressor or an electric generator; then, the flue gas may be discharged in the atmosphere. In order to maintain low undesired emissions (e.g. harmful emissions), the system is provided with a continuous emissions monitoring system, typically consisting in an arrangement of sensors, or a predictive emissions monitoring system, typically consisting in an hardware and/or software analyzer, which respectively measure or predict a NOx and/or CO and/or CO2 amount in the expanded flue gas and provide the amount(s) to the control unit, which controls the content of the gas mixture based on the amount(s) measured or predicted.

Reference now will be made in detail to embodiments of the disclosure, examples of which are illustrated in the drawings. The examples and drawing figures are provided by way of explanation of the disclosure and should not be construed as a limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

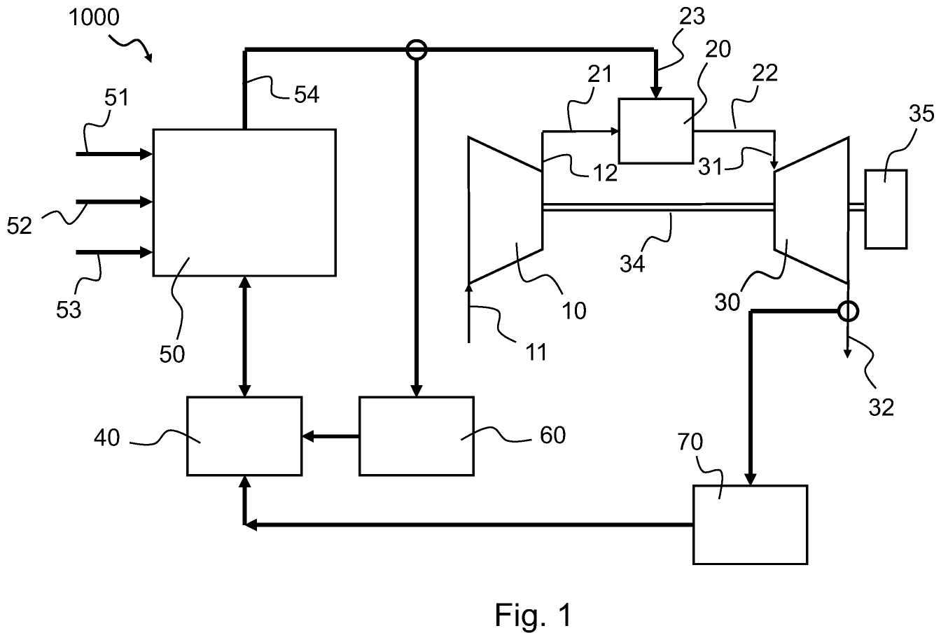

In FIG. 1 there is shown a simplified diagram of an embodiment of a gas turbine system with diffusion-flame combustion and fuel blending generally indicated with reference numeral 1000. The gas turbine system 1000 comprises a compressor section 10, combustor section 20 and a turbine section 30. Typically, the compressor section 10 and the turbine section 30 are mechanically coupled by a shaft 34; advantageously, the shaft 34 is further mechanically coupled to a driven equipment 35, for example a compressor or an electric generator.

The compressor section 10 has a compressor inlet 11 and a compressor outlet 12 and is configured to receive an uncompressed oxidant flow at the compressor inlet, preferably air, more preferably ambient air at ambient pressure, to compress the oxidant for example through one or more compressor stage, and to provide a compressed oxidant flow at the compressor outlet 12. As it will be apparent from the following, the compressed oxidant flow is then supplied to the combustor section 20 of the gas turbine system 1000.

The combustor section 20 has a combustor inlet 21 and a combustor outlet 22 and is configured to receive the compressed oxidant flow from the compressor section 10, in particular from the compressor outlet 12; in other words, the combustor inlet 21 is fluidly coupled to the compressor outlet 12. The combustor section 20 is configured to perform diffusion-flame combustion of a fuel and an oxidant in a combustion chamber: the combustion chamber is fluidly coupled to the combustor inlet 21, receiving the compressed oxidant, and to a fuel supply conduit 23, receiving a fuel; as it will better explained in the following, the fuel received in the combustion chamber is a gas mixture of a fuel gas and an inert gas. The combustion performed in the combustor section 20 generates a flue-gas flow which is provided at the combustor outlet 22.

The combustor outlet 22 is fluidly coupled to the turbine section 30. The turbine section 30 has a turbine inlet 31 and a turbine outlet 32 and is configured to expand the flue-gas flow, for example through one or more expansion stage, and to discharge an expanded flue-gas flow at the turbine outlet 32, which typically ends up in atmosphere.

As already explained above, the combustor section 20 is configured to receive a gas mixture of at least fuel gas and an inert gas: the gas turbine system 1000 further comprises a blending unit 50 configured to mix the fuel gas and the inert gas and to provide the gas mixture to the combustor section 20. The blending unit 50 has at least a fuel-gas inlet 51 and an inert-gas inlet 52 and a gas-mixture outlet 54, the gas-mixture outlet 54 being fluidly coupled to the fuel supply conduit 23 of the combustor section 20 to provide the gas mixture to the combustor section 20. In particular, the blending unit 50 is located upstream the combustor section 20.

According to a preferred embodiment, the fuel gas may be for example hydrogen or a gas mixture containing predominantly hydrogen, e.g. containing at least 90% hydrogen (depending for example on the purity of hydrogen supplied to the blending unit 50). According to a preferred embodiment, the inert gas may contain nitrogen and/or carbon dioxide and/or argon and/or helium and/or a mixture of them; it is not to be excluded that H₂O may be used as “inert gas” (either alone or in combination with one or more other inert gasses) even if less “inert”, preferably in the form of steam or nebulized water or atomized water; preferably the inert gas is nitrogen or contains predominantly nitrogen, e.g. containing at least 90% nitrogen (depending for example on the purity of nitrogen supplied to the blending unit 50). For example, the inert gas may be nitrogen coming from an air separation unit (=ASU). By using hydrogen or a gas mixture containing predominantly hydrogen as fuel gas CO and CO2 emissions are extremely low (if not null);

this is not true, if natural gas or ammonia or LPG or biofuel or electrofuel or syngas is alternatively used as fuel.

There are so many possibilities of composition of the fuel gas mixture. According to a first possibility, the gas mixture supplied to the combustor section 20 at a certain time may contain for example substantially e.g. approximately 60% by volume of hydrogen and e.g. approximately 40% by volume of nitrogen; advantageously, this composition of the gas mixture allows to generate neither CO nor CO2 in the flue gas, as the main product of this combustion is H₂O. It is also to be noted that, in general, if the inert content in the gas mixture is increased, there may be a positive effect on the power output of the gas turbine system 1000, as expanding mass flow rate in the turbine section 30 is increased (the inert gas is heated up in the combustor section 20 and may expand in the turbine section 30) while the compressing mass flow rate does not change (the amount of oxidant compressed by the compression section 10 does not change as the inert gas does not affect the combustion reaction). According to particular operating conditions, if hydrogen is insufficient, the hydrogen content in the gas mixture could be less than e.g. 60% (for example when hydrogen is obtained from renewable sources, in particular from intermittent renewable sources) and an additional fuel-gas may be added to the gas mixture, as it will better explained below. According to other particular operating conditions, for example at the start-up of a turbine, an additional fuel-gas may be added to the gas mixture (or even totally replace hydrogen), as it will better explained below. It is to be noted that, in general, the composition of the fuel gas mixture may not be the same at all times for different reasons (including that the composition is controlled by a control unit) and may vary from one embodiment to another.

As shown in FIGS. 1-3, the blending unit 50, 150, 250 may further comprises an additional fuel-gas inlet 53, 153, 253; for example, the additional fuel gas may contain natural gas and/or ammonia and/or LPG (=Liquefied Petroleum Gas) and/or biofuel (i.e. fuel produced from biomass) and/or electrofuel (i.e. fuel produced with fossil free electricity, or electricity derived from renewable sources) and/or syngas (i.e. a gas mixture consisting primarily of hydrogen and carbon monoxide) and/or CO. The additional fuel gas may be mixed with the fuel gas and the inert gas by the blending unit 50, 150, 250 and the resulting gas mixture may be provided at the gas-mixture outlet 54, 154, 254 of the blending unit 50, 150, 250. The use of additional fuel gas may be advantageous especially during start-up of the gas turbine system 1000, 2000, 3000. For example, the CO may react with O2 according to the following reaction:

2CO+O2→2CO2.

With non-limiting reference to FIGS. 1-3, the gas turbine system 1000 and 2000 and 3000 further comprises a control unit 40, 140, 240 configured to control operation of the gas turbine system, in particular to control opening and closing of a fuel gas regulation valve and an inert gas regulation valve and an additional fuel gas regulation valve (if an additional fuel gas is provided) of the blending unit 50, 150, 250. The blending unit 50, 150, 250 generates the gas mixture under control of the control unit 40, 140, 240. As it will be apparent from the following, a content of the flue gas, for example a content of NOx and/or a content of CO and/or a content of CO2 at the turbine outlet 32, 132, 232 is measured and/or predicted and is provided to the control unit 40, 140, 240. Advantageously, the control unit 40 regulates opening and closing of regulation valves depending on the measured/predicted content of the flue gas. In other words, the gas mixture has a blending ratio depending on the measured/predicted content of the flue gas.

FIG. 1 shows an embodiment of gas turbine system 1000 comprising further a continuous emissions monitoring system (=CEMS) 70 which is fluidly coupled to the turbine outlet 32 and is configured to determine at least a parameter of the expanded flue-gas flow at the turbine outlet 32. Typically, as already mentioned, the continuous emissions monitoring system 70 consists in an arrangement of sensors which can measure one or more parameters to be controlled. Advantageously, the continuous emissions monitoring system 70 may measure a NOx amount in the expanded flue-gas flow and/or a CO amount in the expanded flue-gas flow and or a CO2 amount in the expanded flue-gas flow. The continuous emissions monitoring system 70 may provide the parameter(s) to the control unit 40 which controls operation of the gas turbine system 1000 based on the parameter(s) measured, preferably based on at least the NOx amount in the expanded flue-gas flow and/or the CO amount in the expanded flue-gas flow and/or the CO2 amount in the expanded flue-gas flow; in particular, as already mentioned, the control unit 40 may control opening and closing of regulation valves based on parameter(s) detected by the continuous emissions monitoring system 70.

Advantageously, the gas turbine system 1000 may further comprise instrumentation, in particular sensors, which measure other parameters (these instrumentation may also be totally or partially integrated into the blending unit and/or the compressor section and/or the combustor section and/or the turbine section), such as:

ambient pressure and temperature; and/or

expanded flue-gas temperature; and/or

ambient relative humidity; and/or

pressure drop between compressor inlet 11 and ambient pressure and/or

pressure drop between turbine outlet 32 and ambient pressure and/or

oxidant (e.g. air) pressure and temperature at compressor outlet 12; and/or

flame temperature; and/or

flame stability and dynamics; and/or

fuel composition and properties (pressure, temperature, Lower Heating Value=LHV, Modified Wobbe Index=MWI, flammability ratio . . . ).

Advantageously, one or more of these other parameters may be supplied to the control unit 40 which may take them in account to control the operation of the gas turbine system 1000, in particular performing a trade-off between amount of undesired emissions (e.g. NOx and/or CO and/or CO2) and gas turbine performance. Advantageously, the control unit 40 may also control operation of the gas turbine system 1000 taking in account aging phenomenon on gas turbine system and/or mechanical deterioration/wear of hot gas components (i.e. gas turbine components which are exposed to high-temperature flows), for example based on predictions and gas turbine performance maps. It is to be noted that the control unit 40 may be further connected to a fuel gas analyzer 60, fluidly coupled to the gas-mixture outlet 54, which may provide information about the gas mixture at the gas-mixture outlet 54; for example, the fuel gas analyzer 60 may measure the composition and properties specified above. Advantageously, the control unit 40 controls the content of the gas mixture further based on the information provided by the fuel gas analyzer 60.

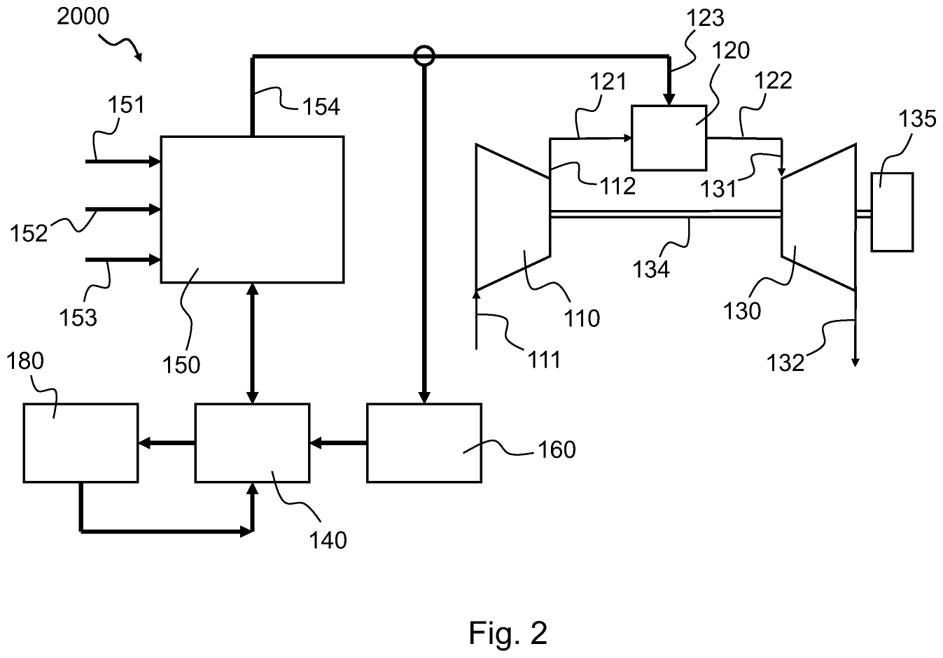

FIG. 2 shows another embodiment of gas turbine system 2000 which is similar to the embodiment of FIG. 1 and differs at least in that the parameter(s) of the expanded flue-gas flow at the turbine outlet 132 is predicted instead of being measured. The gas turbine system further comprises a predictive emissions monitoring system 180 which receives information about the gas mixture at the gas-mixture outlet 154 of the blending unit 150. In particular, the predictive emissions monitoring system 180 may be configured to receive at least the blending ratio (e.g. of the fuel and the inert gas) or a content of the gas mixture (e.g. of the fuel, the inert gas and the additional fuel) at the gas-mixture outlet 154 of the blending unit 150. Advantageously, the information about the gas mixture (in particular its content) is provided to the predictive emissions monitoring system 180 by the control unit 140, which is connected to a fuel gas analyzer 160 fluidly coupled to the gas-mixture outlet 154; in other words, the fuel gas analyzer 160 is configured to provide information to the control unit 140 about the gas mixture (in particular its actual content) at the gas-mixture outlet 154, Advantageously, the predictive emissions monitoring system 180 may be also configured to receive information about temperature and/or pressure of the gas mixture at the gas-mixture outlet 154, the temperature and/or pressure being measured by the fuel gas analyzer 160 and being supplied to the control unit 140.

The predictive emissions monitoring system 180 is configured to predict at least a parameter of the expanded flue-gas flow at the turbine outlet 32, in particular based on the information about the gas mixture received. Advantageously, the predictive emissions monitoring system 180 may predict a NOx amount in the expanded flue-gas flow and/or a CO amount in the expanded flue-gas flow and/or a CO2 amount in the expanded flue-gas flow. The predictive emissions monitoring system 180 may provide the parameter(s) to the control unit 140 which controls operation of the gas turbine system 2000 based on the parameter(s) predicted, preferably based on at least the NOx amount in the expanded flue-gas flow and/or the CO amount in the expanded flue-gas flow and/or the CO2 amount in the expanded flue-gas flow; in particular, as already mentioned, the control unit 140 may control opening and closing of regulation valves based on parameter(s) predicted by predictive emissions monitoring system 180.

Advantageously, the gas turbine system 2000 may further comprise instrumentation, in particular sensors, which measure other parameters (these instrumentation may also be totally or partially integrated into the blending unit and/or the compressor section and/or the combustor section and/or the turbine section), such as:

ambient pressure and temperature; and/or

expanded flue-gas temperature; and/or

ambient relative humidity; and/or

pressure drop between compressor inlet 11 and ambient pressure and/or

pressure drop between turbine outlet 32 and ambient pressure and/or

oxidant (e.g. air) pressure and temperature at compressor outlet 12; and/or

flame temperature; and/or

flame stability and dynamics; and/or

fuel composition and properties (pressure, temperature, Lower Heating Value=LHV, Modified Wobbe Index=MWI, flammability ratio . . . ).

Advantageously, one or more of these other parameters may be supplied to the control unit 140 which may take them in account to control the operation of the gas turbine system 2000, in particular performing a trade-off between amount of undesired emissions (e.g. NOx and/or CO and/or CO2) and gas turbine performance. Advantageously, the control unit 140 may also control operation of the gas turbine system 2000 taking in account aging phenomenon on gas turbine system and/or mechanical deterioration/wear of hot gas components (i.e. gas turbine components which are exposed to high-temperature flows), for example based on predictions and gas turbine performance maps.

It is to be noted that according to some embodiments, one or more emissions may be measured as shown in FIG. 1 and one or more emissions may be predicted as shown in FIG. 2.

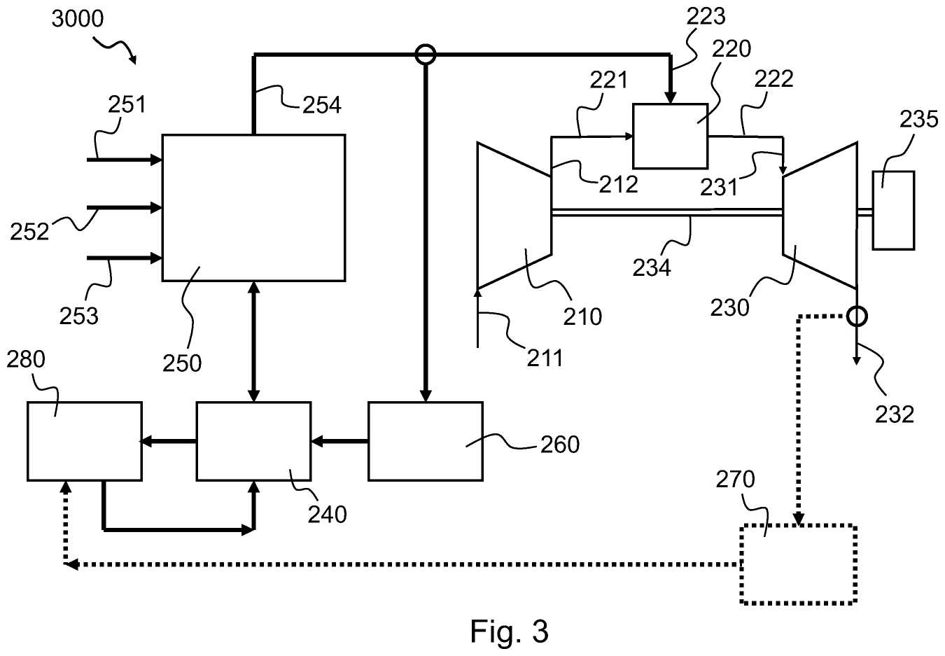

The embodiment of the gas turbine system 3000 of FIG. 3 is similar to the embodiment of FIG. 1 and differs at least in that the predictive emissions monitoring system is configured to make predictions based on Artificial Intelligence (=AI), in particular it comprises an artificial neural network configured to contribute the predictions.

The embodiment 280 of the predictive emissions monitoring system has inputs configured to be electrically coupled to a continuous emissions monitoring system 270 being fluidly coupled to the turbine outlet 232 and configured to measure turbine emissions, in particular NOx emission and/or CO2 emission and/or CO emission; typically, the continuous emissions monitoring system 270 consists in an arrangement of sensors, in particular a NOx meter and/or a CO2 meter and/or a CO meter. System 270 and the connection lines are drawn with dashed lines as the continuous emissions monitoring system may not be a permanent component of the gas turbine system and may be present only during an installation phase (e.g. for the first e.g. 2-20 hours of operation) and/or during an initial operation phase (e.g. for the first e.g. 200-2000 hours of operation) and/or during system operation checks. The AI-based predictive emissions monitoring system 280 may be configured to be set up (e.g. calibrated) at factory and/or at installation, and may be configured to be trained at installation and/or during initial operation, wherein training is based on the emissions actually measured at the outlet of the gas turbine system.

According to some variants of the embodiment of FIG. 3, the continuous emissions monitoring system 270 may be permanently present and may be used for example not only for training the AI-based predictive emissions monitoring system 280, but also for other purposes.

The gas turbine system 1000, 2000, 3000 shown in FIGS. 1-3 may implement a method for reducing undesired emissions, for example harmful emissions, in particular a content of NOx and/or CO and/or CO2 in the flue gas discharged from the turbine outlet 32, 132, 232, by regulating the blending ratio of the gas mixture of a fuel gas and an inert gas to be supplied to the combustor section 20, 120, 220 (and eventually the content of the gas mixture of a fuel gas, an inert gas and an additional fuel gas). As already mentioned, the content of NOx and/or CO and/or CO2 in the flue gas may be measured by the continuous emission monitoring system 70, 270 and/or predicted by a predictive emission monitoring system 180, 280 and the content measured and/or predicted is provided to the control unit 40, 140, 240, such that the blending ratio or the content of the gas mixture is regulated (substantially in real time) by the control unit 40, 140, 240. However, the control unit 40, 140, 240 may control operation of the gas turbine system by optimizing other parameters as well, preferably by performing a trade-off between content of NOx and/or CO and/or CO2 in the flue gas (whose maximum values are regulated and vary by country) and performance of the gas turbine system, such as power output and/or efficiency.

According to a first possibility, if the gas turbine system operating conditions are high temperature and high relative humidity of ambient air (for example T=40° C., RH=0.85), the content of NOx and/or CO and/or CO2 in the flue gas is less than the content of NOx and/or CO and/or CO2 in the flue gas in ISO conditions (T=15° C., RH=0.6); therefore, the content of nitrogen in the gas mixture may be reduced, advantageously reducing the power output of the gas turbine system. According to another possibility, if the content of CO and/or CO2 in the flue gas increases, the power output may be substantially kept constant by increasing the hydrogen and nitrogen content in the gas mixture. According to another possibility, the content in volume of inert gas could be increased up to the design limit of the diffusion-flame combustion performed by the combustor section of the system.

It is to be noted that the gas turbine system 1000, 2000 and 3000 disclosed herein may also be provided with other solutions and/or devices for the reduction or the removal of pollutants in the exhaust gases, for example steam injection into the combustion chamber.

1. A gas turbine system comprising:
a compressor section having a compressor inlet and a compressor outlet, wherein the compressor section is configured to receive an uncompressed oxidant flow at the compressor inlet, to compress the oxidant, and to provide a compressed oxidant flow at the compressor outlet,
a combustor section having a combustor inlet and a combustor outlet and a fuel supply conduit, the combustor inlet being fluidly coupled to the compressor outlet, wherein the combustor section comprises a combustion chamber fluidly coupled to the combustor inlet and the combustor outlet and the fuel supply conduit and is configured to perform diffusion-flame combustion of a fuel and an oxidant in the combustion chamber and to provide a flue-gas flow at the combustor outlet,
a turbine section having a turbine inlet and a turbine outlet), the turbine inlet being fluidly coupled to the combustor outlet, wherein the turbine section is configured to expand the flue-gas flow and to discharge an expanded flue-gas flow at the turbine outlet,
a control unit configured to control operation of the gas turbine system,
wherein the gas turbine system further comprises a blending unit having a fuel-gas inlet and an inert-gas inlet and a gas-mixture outlet, the gas-mixture outlet being fluidly coupled to the fuel supply conduit of the combustor section,
wherein the gas turbine system further comprises a fuel gas analyzer configured to determine a content of the gas mixture at the gas-mixture outlet and to provide the content to the control unit,
wherein the blending unit is configured to mix a fuel gas and an inert gas and provide a gas mixture at the gas-mixture outlet under control of the control unit, the gas mixture having a blending ratio depending on a content of the flue gas.

2. The gas turbine system of claim 1, wherein the fuel gas is hydrogen or a gas mixture containing predominantly hydrogen.

3. The gas turbine system of claim 1, wherein the inert gas contains nitrogen and/or carbon dioxide and/or argon and/or helium and/or H2O and/or a mixture of them, preferably the inert gas is nitrogen or a gas mixture containing predominantly nitrogen.

4. The gas turbine system of claim 1, wherein the blending unit further comprises an additional fuel-gas inlet wherein the blending unit is configured to mix the fuel gas, the additional fuel gas and the inert gas and provide the gas mixture at the gas-mixture outlet

5. The gas turbine system of claim 4, wherein the additional fuel gas contains natural gas and/or ammonia and/or LPG and/or biofuel and/or electrofuel and/or syngas and/or CO.

6. The gas turbine system of claim 1, further comprising a continuous emissions monitoring system fluidly coupled to the turbine outlet and configured to measure at least one parameter of the expanded flue-gas flow and provide the at least one parameter to the control unit, wherein the at least one parameter is a NOx amount in the expanded flue-gas flow.

7. The gas turbine system of claim 6, wherein the continuous emissions monitoring system is further configured to measure at least another parameter of the expanded flue-gas flow and provide the at least another parameter to the control unit, wherein the at least another parameter is a CO and/or a CO2 amount in the expanded flue-gas flow.

8. The gas turbine system of claim 1, further comprising a predictive emissions monitoring system configured to receive at least the blending ratio or a content of the gas mixture at the gas-mixture outlet from the control unit and to predict at least one parameter of the expanded flue-gas flow and provide the at least one parameter to the control unit, wherein the at least one parameter is a NOx amount in the expanded flue-gas flow.

9. The gas turbine system of claim 8, wherein the predictive emissions monitoring system is further configured to predict at least another parameter of the expanded flue-gas flow and provide the at least another parameter to the control unit, wherein the at least another parameter is a CO and/or a CO2 amount in the expanded flue-gas flow.

10. The gas turbine system of claim 6, wherein the control unit controls operation of the gas turbine system, based on the at least one parameter measured or predicted.

11. The gas turbine system-999 99 of claim 7, wherein the control unit controls operation of the gas turbine system, based on the at least another parameter measured or predicted.

12. The gas turbine system of claim 1, wherein the blending unit comprises a fuel gas regulation valve and an inert gas regulation valve, wherein the control unit is configured to regulate opening and closing of the fuel gas regulation valve and the inert gas regulation valve.

13. The gas turbine system of claim 4, wherein the blending unit further comprises a regulation valve of the additional fuel-gas, wherein the control unit is configured to regulate opening and closing of the regulation valve of the additional fuel-gas.

14. The gas turbine system of claim 8, wherein the predictive emissions monitoring system is configured to make predictions based on artificial intelligence, in particular it comprises an artificial neural network configured to contribute the predictions.

15. The gas turbine system of claim 14, further comprising:
a continuous emissions monitoring system fluidly coupled to the turbine outlet, electrically coupled to the predictive emissions monitoring system, and configured to measure turbine emissions, or
inputs configured to be electrically coupled to a continuous emissions monitoring system, the continuous emissions monitoring system being fluidly coupled to the turbine outlet and configured to measure turbine emissions;
wherein the predictive emissions monitoring system is configured to be set up at factory and/or at installation, and configured to be trained at installation and/or during initial operation, wherein training is based on the measured emissions.
